(19) United States
(12) Patent Application Publication
(10) Pub. No.: US 2007/0138421 A1
(43) Pub. Date: Jun. 21, 2007

(54) Tri-state control for an electronic faucet

(75) Inventors: Jeffrey John Gibson, London (CA); John Vincent Robinson, Delaware (CA); Jeffrey Iott, Monroe, MI (US); Jeffrey Belz, Eastpointe, MI (US)

Correspondence Address: CARLSON, GASKEY & OLDS, P.C., 400 WEST MAPLE ROAD, SUITE 350, BIRMINGHAM, MI, 48009, US

(73) Assignee: Masco Corporation

(21) Appl. No.: 11/312,136

(22) Filed: Dec. 20, 2005

(51) Int. Cl. F16K 31/02

(52) U.S. Cl. 251/129.04

(57) ABSTRACT

An electronic faucet includes a control that has at least three different modes of operation. The control has an auto or normal mode of operation where fluid flows for a predetermined amount of time when a sensor detects an object adjacent to the electronic faucet. The control has an “off” mode where system electronics are disabled such that fluid cannot flow, and the control has an “on” mode where fluid is constantly flowing. A mechanical or electronic selector is selectively actuated to place the control in one of the auto, off, or on modes.

### TECHNICAL FIELD

The subject invention relates to an electronic faucet with a control that is selectively actuated to change between different operational modes.

### BACKGROUND OF THE INVENTION

Electronic faucets include a sensor that detects an object near the electronic faucet. When an object is detected, water is automatically turned on for a time interval that comprises a predetermined amount of time. Water is automatically shut off when this time interval expires or no object is detected. The water will be automatically turned back on for the same predetermined amount of time as long as the sensor detects an object.

One current system allows the time interval for the fluid flow to be selectively varied. Thus, the system can be set to flow for a desired time interval, such as 10 seconds, 20 seconds, etc., each time an object is detected by the sensor.

One disadvantage with current systems is that the control cannot be selectively modified to allow continuous flow. The control also cannot be modified to prohibit any flow from occurring. In certain environments, there is a need for electronic faucets to be put in a no-flow mode of operation for maintenance purposes or cleaning purposes. There is also a need to allow for continuous purging flow such that the electronic faucet can be sanitized. Thus, it would be desirable to provide an electronic faucet control that can be selectively put into different operational modes.

### SUMMARY OF THE INVENTION

An electronic faucet includes a control that is selectively actuated to change between different operational modes. Each operational mode has a unique flow characteristic. A selector is actuated to put the control in a desired one of the operational modes.

In one example, the control includes at least three different operational modes. A first operational mode has a first flow characteristic, a second operational mode has a second flow characteristic, and a third operational mode has a third flow characteristic. The first flow characteristic comprises a continuous flow, the second flow characteristic comprises an intermittent flow, and the third flow characteristic comprises a no-flow condition. The intermittent flow comprises a flow condition that is the traditional flow in response to a sensed object.

The selector is selectively actuated to change the control between the first, second, and third operational modes. In one example, the selector comprises a key that is moved into a desired one of the operational modes.

The electronic faucet includes a unique control system that allows different operational modes to be selected as needed. These and other features of the present invention can be best understood from the following specification and drawings, the following of which is a brief description.

### BRIEF DESCRIPTION OF THE DRAWINGS

FIG. 1 is a schematic view of an electronic faucet incorporating the subject invention.

FIG. 2 is a flow chart showing one example operational configuration.

### DETAILED DESCRIPTION OF THE PREFERRED EMBODIMENT

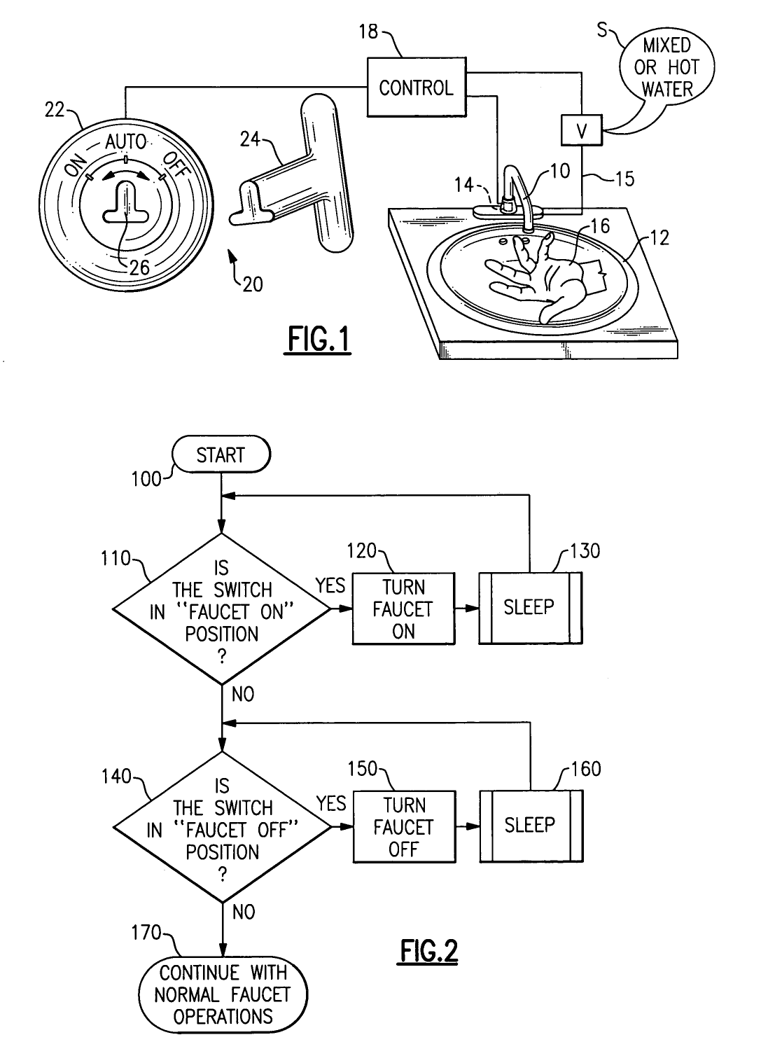

An electronic faucet 10 for a sink 12 is shown in FIG. 1. The electronic faucet 10 includes at least one sensor 14 that is used to detect an object 16, such as a hand for example, near the electronic faucet 10. The electronic faucet 10 also includes a control 18 that is in communication with the sensor 14, and a selector 20 that is in communication with the control 18. The selector 20 is selectively actuated to put the control 18 in one of a plurality of different operational modes.

Preferably, the control 18 has at least three (3) different operational modes that each have a unique flow characteristic. A first operational mode comprises an “on” mode and has a constant water flow. This allows the electronic faucet 10 and an associated supply line 15 to be cleaned by a continuous purge. The electronic faucet 10 will remain in this “on” mode until another mode of operation is selected.

When in the “on” mode, the fluid supply S is activated by the control 18 to flow through the electronic faucet 10. For example, during cleaning a hotter temperature of water may be required to sanitize the electronic faucet 10. By selecting the “on” mode, the control 18 could generate a control signal to activate a valve V to allow continuous fluid flow of hot water until the electronic faucet 10 and supply line 15 have been sufficiently cleaned. When moved out of the “on” mode, the control 18 would close the valve V.

A second operational mode comprises an auto or normal mode of operation where water flow is intermittent. When in the auto mode of operation, fluid flows for intermittent time intervals in response to a detection of an object 16 by the sensor 14. When an object 16 is detected, water is automatically turned on for a time interval that comprises a predetermined amount of time or when the object 16 is removed. Water is automatically shut off when this time interval expires or when the object 16 is removed. The water will be automatically turned back on for the same predetermined amount of time as long as the sensor 14 detects the object 16. If the sensor 14 does not detect an object 16, the water will not be turned on. This is the normal mode of operation for current electronic faucets.

A third operational mode comprises an “off” or “no-flow” mode of operation where water is prohibited from flowing. In this mode, system electronics are disabled and water cannot be triggered to flow under any condition. This allows the sink 12 and/or electronic faucet to be serviced or cleaned as needed.

In the example shown, the selector 20 comprises a switch body 22 that is activated by a key 24. The key 24 is inserted into a hole 26 formed within the switch body 22. When the key 24 is in a center poison as shown, the control 18 is in the auto or normal mode of operation. The key 24 is rotated in a clockwise direction to place the control 18 in the “off” mode. The key 24 is rotated in a counter-clockwise direction to place the control 18 in the “on” mode. It should be understood that a key is just one example configuration for a selector 20 and that other types of selectors could be used to change between the different operational modes of the electronic faucet 10.

Current electronic faucets include a microcontroller. The control 18 for the subject invention uses two (2) of the inputs of the current microcontroller with the selector 20. The control 18 reads a position of the selector 20 as either a logic high or a logic low. If a logic low is detected, an active designation is determined and the control 18 issues a signal to place the electronic faucet 10 in the desired mode of operation. If a logic high is detected on both inputs then the control 18 maintains the normal or auto mode of operation.

One example control system process is shown in FIG. 2. The control 18 starts at step 100 and determines at step 110 whether the selector 20 is in the on position. If the selector 20 is in the on position, the control 18 turns the electronic faucet 10 on as indicated at step 120 for constant flow, and then enters a sleep mode as indicated at step 130. The control 18 remains in the sleep mode until the selector 20 is moved to a different position and the control 18 determines that the selector is no longer in the on position.

If the selector 20 is not in the on position, the control 18 then determines if the selector 20 is in the off position, as shown at step 140. If the selector 20 is in the off position, the control 18 shuts off the water as indicated at step 150, and enters a sleep mode as indicated at step 160. Once in this mode, nothing can trigger the water to flow. The control 18 remains in the sleep mode until the selector 20 is moved to a different position and the control 18 determines that the selector is no longer in the off position.

If the selector 20 is not in the off position and is not in the on position, the control 18 continues with normal faucet operation as indicated at step 170. When in this mode, the electronic faucet 10 provides intermittent flow in response to a sensed object 16 as described above. The electronic faucet 10 remains in the mode until the selector 20 is moved into either the off or on position.

It should be understood that while a single electronic faucet 10 is shown in FIG. 1, the control 18 could be used to control a series of electronic faucets 10 in a bank of sinks 12, such as in a public restroom for example. The control 18 could use a single selector 20 for each electronic faucet 10 to provide individual control, or could use one common selector 20 to control operation of all of the electronic faucets 10.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An electronic faucet comprising:
a control having at least a first operational mode for a first flow characteristic and a second operational mode for a second flow characteristic different from the first flow characteristic; and
an actuator that is selectively actuated to change said control between said first and said second operational modes.

2. The electronic faucet according to claim 1 wherein said first flow characteristic comprises a continuous flow and said second flow characteristic comprises an intermittent flow.

3. The electronic faucet according to claim 1 wherein said first flow characteristic comprises a no-flow condition and said second flow characteristic comprises an intermittent flow.

4. The electronic faucet according to claim 1 wherein said actuator comprises a selector switch that is selectively movable between said first and said second operational modes by one of a mechanical device and an electronic device.

5. The electronic faucet according to claim 1 including a third operational mode having a third flow characteristic different from said first and said second flow characteristics wherein said first flow characteristic comprises a continuous flow, said second flow characteristic comprises an intermittent flow, and said third flow characteristic comprises a no-flow condition.

6. The electronic faucet according to claim 5 including at least one sensor to detect an object adjacent the electronic faucet wherein said control activates fluid flow for a predetermined time interval when said control is in said second operational mode and said at least one sensor detects an object, and wherein said control stops fluid flow when in said second operational mode and said at least one sensor does not detect an object.

7. An electronic faucet comprising:
a control having at least a first operational mode for a first flow characteristic, a second operational mode for a second flow characteristic different from the first flow characteristic, and a third operational mode for a third flow characteristic different from said first and said second flow characteristics;
at least one sensor that generates a detection signal that is communicated to said control when an object is adjacent to the electronic faucet; and
a selector that is selectively movable to place said control in one of said first, said second, and said third operational modes.

8. The electronic faucet according to claim 7 wherein said first flow characteristic comprises a continuous flow, said second flow characteristic comprises an intermittent flow, and said third flow characteristic comprises a no-flow condition.

9. The electronic faucet according to claim 8 wherein said control activates fluid flow for a predetermined time interval when said control is in said second operational mode and said at least one sensor detects an object.

10. The electronic faucet according to 8 wherein said control prohibits fluid flow when said control is in said second operational mode and said at least one sensor does not detect an object adjacent to the electronic faucet.

11. The electronic faucet according to claim 8 wherein said selector comprises one of a mechanical device and an electronic device that is actuated to change between said first, said second, and said third operational modes.

12. A method for controlling fluid flow in an electronic faucet comprising the steps of:
(a) assigning a first flow characteristic to a first operational mode and a second flow characteristic to a second operational mode wherein the second flow characteristic is different from the first flow characteristic; and
(b) selecting one of the first and second operational modes.

13. The method according to claim 12 including the steps of defining the first flow characteristic as a constant fluid flow, and defining the second flow characteristic as an intermittent flow where fluid flows for a predetermined time interval only in response to a sensed object near the electronic faucet.

14. The method according to claim 12 including the steps of defining the first flow characteristic as a no-flow condition, and defining the second flow characteristic as an intermittent flow where fluid flows for a predetermined time interval only in response to a sensed object near the electronic faucet.

15. The method according to claim 12 including the steps of assigning a third flow characteristic to a third operational mode, defining the first flow characteristic as a continuous flow, defining the second flow characteristic as an intermittent flow, and defining the third flow characteristic as a no-flow condition.

16. The method according to claim 15 wherein the intermittent flow includes the steps of allowing fluid flow for a predetermined time interval when an object is sensed near the electronic faucet, and stopping fluid flow when the predetermined time interval has expired or the object is removed.

17. The method according to claim 16 including the step of disabling sensing electronics when the electronic faucet is in the third mode of operation.
